(19) United States
(12) Patent Application Publication
(10) Pub. No.: US 2020/0019786 A1
(43) Pub. Date: Jan. 16, 2020

(54) AUTOMATED LABELING OF FEATURES IN VIDEO FRAMES

(71) Applicant: ELEMENT AI INC., Montreal (CA)

(72) Inventors: Eric ROBERT, Montreal (CA); Jean-Sébastien BÉJEAU, Montreal (CA); Saad TAZI, Montreal (CA)

(21) Appl. No.: 16/507,698

(22) Filed: Jul. 10, 2019

Related U.S. Application Data
(60) Provisional application No. 62/695,894, filed on Jul. 10, 2018.

(51) Int. Cl. G06K 9/00; G06K 9/62; G06T 7/73

(52) U.S. Cl. CPC G06K 9/00718; G06K 9/6202; G06T 7/74; G06T 2207/20084; G06K 9/00744; G06T 2207/10016; G06K 9/6256

(57) ABSTRACT

Systems and methods for automatic labeling of unlabeled video frames from a video sequence, based on known features in other frames in the sequence. An unlabeled video frame and a labeled video frame are received by an identification module. The unlabeled frame and the labeled video frame are temporally close to each other within the video sequence and preferably temporally adjacent. The identification module recognizes labeled features within the labeled frame. The identification module then identifies multiple potential features within the unlabeled frame. A comparison module then compares each potential feature in the unlabeled frame to the recognized labeled feature in the labeled frame. If a match is found, a labeling module applies a label to the potential feature in the unlabeled frame, thereby producing a newly labeled frame. The labeling process repeats until all frames in the sequence have been labeled.

### RELATED APPLICATIONS

This application is a non-provisional patent application which claims the benefit of U.S. Provisional Application No. 62/695,894 filed on Jul. 10, 2018.

### TECHNICAL FIELD

The present invention relates to labeled and unlabeled images. More specifically, the present invention relates to systems and methods for labeling unknown features in a sequence of images based on previously labeled images within that sequence.

### BACKGROUND

The field of machine learning is a burgeoning one. Daily, more and more uses for machine learning are being discovered. Unfortunately, to properly use machine learning, data sets suitable for training are required to ensure that systems accurately and properly accomplish their tasks. As an example, for systems that recognize cars within images, training data sets of labeled images containing cars are needed. Similarly, to train systems that, for example, track the number of trucks crossing a border, data sets of labeled images containing trucks are required.

As is known in the field, these labeled images are used so that, by exposing systems to multiple images of the same item in varying contexts, the systems can learn how to recognize that item. However, as is also known in the field, obtaining labeled images which can be used for training machine learning systems is not only difficult, it can also be quite expensive. In many instances, such labeled images are manually labeled, i.e., labels are assigned to each image by a person. Since data sets can sometimes include thousands of images, manually labeling these data sets can be a very time-consuming task.

It should be clear that labeling video frames also runs into the same issues. As an example, a 15-minute video running at 24 frames per second will have 21,600 frames. If each frame is to be labeled so that the video can be used as a training data set, manually labeling the 21,600 frames will take hours if not days.

Moreover, manually labeling those video frames will likely introduce substantial error. Selecting, for instance, ‘the red car’ in 21,600 frames is a tedious task in addition to a time-consuming one. The person doing that labeling is likely to lose focus from time to time, and their labels may not always be accurate.

In addition, if the video was taken from a moving vantage point (such as a video capture device attached to a moving vehicle), features present in one frame may not look identical to the same features in another frame. For instance, important features may be very small in initial frames of the video but increase in size as the video capture device moves closer to these features. Persons manually labeling each feature would thus have to account for size changes in each frame, making their task more complicated and lengthier.

From the above, there is therefore a need for systems and methods that address the issues noted above. Preferably, such systems and methods would work to ensure the accurate and proper labeling of video frames, regardless of vantage point and scaling.

### SUMMARY

The present invention relates to systems and methods for automatic labeling of unlabeled video frames from a video sequence, based on known features in other frames in the sequence. An unlabeled video frame and a labeled video frame are received by an identification module. The unlabeled frame and the labeled video frame are temporally close to each other within the video sequence and preferably temporally adjacent. The identification module recognizes labeled features within the labeled frame. The identification module then identifies multiple potential features within the unlabeled frame. A comparison module then compares each potential feature in the unlabeled frame to the recognized labeled feature in the labeled frame. If a match is found, a labeling module applies a label to the potential feature in the unlabeled frame, thereby producing a newly labeled frame. The labeling process repeats until all frames in the sequence have been labeled.

In a first aspect, the present invention provides a method for labeling an unlabeled frame within a sequence of frames, the method comprising:

(a) receiving said unlabeled frame and a labeled frame from said sequence, said labeled frame being temporally close to said unlabeled frame within said sequence;

(b) identifying at least one labeled feature in said labeled frame;

(c) identifying at least one potential feature in said unlabeled frame;

(d) comparing said at least one potential feature with said at least one labeled feature; and

(e) applying a label to said unlabeled frame when said at least one potential feature matches said at least one said labeled feature, to thereby produce a newly labeled frame.

In a second aspect, the present invention provides a method for the present invention provides a method for labeling an unlabeled frame within a sequence of frames, the method comprising:

(a) receiving said unlabeled frame and a labeled frame from said sequence, said labeled frame being temporally close to said unlabeled frame within said sequence;

(b) identifying at least one labeled feature in said labeled frame;

(c) identifying a specific location of said at least one labeled feature within said labeled frame;

(d) generating a specific signature of a specific region of said labeled frame, said specific region being based on said specific location;

(e) identifying a similar location within said unlabeled frame, said similar location being a location within said unlabeled frame that is similar to said specific location within said labeled frame;

(f) generating a random trial signature of a random trial region of said unlabeled frame, said random trial region being based on said similar location;

(g) comparing said random trial signature to said specific signature;

(h)repeating steps (f)-(g) until an exit condition is met, wherein said exit condition is one of:
said random trial signature matches said specific signature within a margin of tolerance; and
a predetermined number of iterations are performed.

In a third aspect, the present invention provides a system for labeling an unlabeled frame within a sequence of frames, the system comprising:
an identification module for:
   receiving said unlabeled frame and a labeled frame from said sequence, said labeled frame being temporally close to said unlabeled frame within said sequence;
   identifying at least one labeled feature in said labeled frame; and
   identifying at least one potential feature in said unlabeled frame;
a comparison module for comparing said at least one potential feature to said at least one labeled feature; and
a labeling module for applying a label to said unlabeled frame when said comparison module determines a match between at least one potential feature and at least one labeled feature, said labeling module thereby producing a newly labeled frame.

In a fourth aspect, the present invention provides non-transitory computer-readable media having stored thereon computer-readable and computer-executable instructions, which, when executed, implement a method for labeling an unlabeled frame within a sequence of frames, the method comprising:

(a) receiving said unlabeled frame and a labeled frame from said sequence, said labeled frame being temporally close to said unlabeled frame within said sequence;

(b) identifying at least one labeled feature in said labeled frame;

(c) identifying at least one potential feature in said unlabeled frame;

(d) comparing said at least one potential feature with said at least one labeled feature; and

(e) applying a label to said unlabeled frame when said at least one potential feature matches said at least one said labeled feature, to thereby produce a newly labeled frame.

In a fifth aspect, the present invention provides non-transitory computer-readable media having stored thereon computer-readable and computer-executable instructions, which, when executed, implement a method for labeling an unlabeled frame within a sequence of frames, the method comprising:

(a) receiving said unlabeled frame and a labeled frame from said sequence, said labeled frame being temporally close to said unlabeled frame within said sequence;

(b) identifying at least one labeled feature in said labeled frame;

(c) identifying a specific location of said at least one labeled feature within said labeled frame;

(d) generating a specific signature of a specific region of said labeled frame, said specific region being based on said specific location;

(e) identifying a similar location within said unlabeled frame, said similar location being a location within said unlabeled frame that is similar to said specific location within said labeled frame;

(f) generating a random trial signature of a random trial region of said unlabeled frame, said random trial region being based on said similar location;

(g) comparing said random trial signature to said specific signature;

(h) repeating steps (f)-(g) until an exit condition is met, wherein said exit condition is one of:
said random trial signature matches said specific signature within a margin of tolerance; and
a predetermined number of iterations are performed.

### BRIEF DESCRIPTION OF THE DRAWINGS

The embodiments of the present invention will now be described by reference to the following figures, in which identical reference numerals in different figures indicate identical elements and in which:

FIG. 1 is a diagram showing frames in a video sequence;

FIG. 2 is a block diagram of a system according to one aspect of the invention;

FIG. 3 is a variant of the system illustrated in FIG. 2;

FIG. 4A is an exemplary labeled video frame from a video sequence;

FIG. 4B is an exemplary unlabeled video frame from the video sequence of FIG. 4A;

FIG. 4C is the frame of FIG. 4B with the labels of FIG. 4A applied;

FIG. 4D is the frame of FIG. 4B with properly positioned labels applied;

FIG. 4E is another exemplary unlabeled video frame from the video sequence of FIG. 4A;

FIG. 5 is a flowchart detailing the steps in a method according to another aspect of the present invention; and

FIG. 6 is a flowchart detailing a variant of the method detailed in FIG. 5.

### DETAILED DESCRIPTION

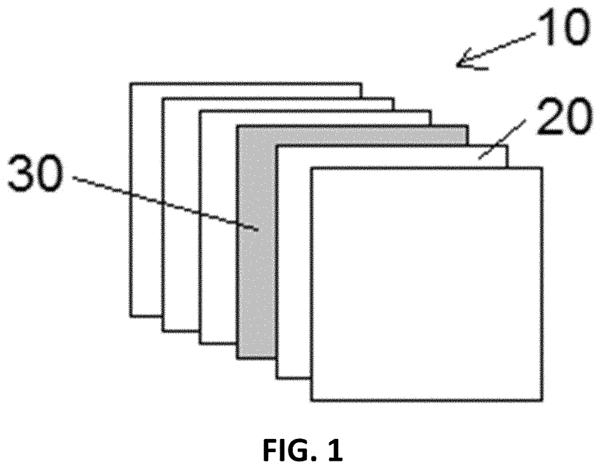

The present invention provides systems and methods that allow for automatic labeling of unlabeled video frames based on labeled frames in the same video sequence. FIG. 1 shows a representative video sequence 10 containing a plurality of frames. In the video sequence 10, unlabeled frame 20 is “temporally close” to labeled frame 30. (Note that the labeled frame 30 here is coloured light grey, but that this colouring is purely for visual distinction within the diagram.) The degree of temporal “closeness” between the unlabeled frame 20 and labeled frame 30 can be defined in various ways. That is, the appropriate degree of closeness may depend on multiple factors, including but not limited to the frame rate of the video, the video length, and, if relevant, the speed at which the video capture device was moving during video capture. In general, however, the unlabeled frame 20 and the labeled frame 30 are temporally close enough that at least one feature is commonly found in both of them. In some embodiments, moreover, the unlabeled frame 20 and the labeled frame 30 can be “temporally adjacent” to each other, meaning that there are no other frames between them in the sequence 10. In other embodiments, the unlabeled frame 20 and the labeled frame 30 are not required to be temporally adjacent to each other but should still be temporally close. For efficiency reasons, however, it is generally preferred that the frames be temporally adjacent to each other.

In some implementations, the label/tag on the labeled frame can be provided by a human In other implementations, the label/tag can be provided by an automated process, with or without human validation. The label/tag can include a bounding box that defines a region of the labeled frame, wherein a specific item is contained within that bounding box. (It should be evident, of course, that a ‘bounding box’ does not have to be rectangular. The term ‘bounding box’ as used herein (and, further, the terms ‘label’ and ‘tag’) indicates an element of any shape, size, or form that delineates, highlights, or separates a feature from the rest of the frame.) In other implementations, the label/tag can include a metadata tag applied to the labeled frame as a whole, indicating the presence or absence of a specific feature within the frame as a whole. Additionally, the label/tag can indicate the location of that specific feature within the frame. In some implementations, labels/tags might function both as binary present/absent indicators and as locators.

It should be noted that, unless otherwise specified, all references herein to the term ‘label/tag’ should be taken to include the plural term ‘labels’. A video frame may show many features that require labeling, or only one, according to the problem at hand. For instance, a video may show a busy highway and a user may seek information about the movement patterns of each car. In such a scenario, there could be multiple bounding boxes defined within each frame, one for each car within view. As another example, a video may show a train track with an approaching signal. If the only important feature is the signal, the labeled frames may only have a single bounding box.

Additionally, it should be evident that FIG. 1 shows a limited and stylized video sequence, containing only six frames, for visual simplicity. As already discussed, video sequences may have tens of thousands of frames, or more, depending on frame rate and video length. It should be noted also that multiple frames within each video sequence can be labeled before being fed to the present invention.

Further, it should be clear that all frames in the video sequence 10 preferably have at least one feature in common (that is, at least one specific feature preferably appears in every frame). Alternatively, even in sequences that do not track a single feature through the entire sequence, it is preferred that each pair of adjacent frames in the sequence has at least one feature in common. Nevertheless, depending on the input sequence, certain pairs of adjacent frames might not have even one feature in common. That is, a labeled feature in a labeled frame may be missing from an adjacent unlabeled frame, due to occlusions within the frame or due to other reasons. In such cases, the present invention will determine that the feature is not present in the unlabeled frame and will select another unlabeled frame to examine. (Of course, if there is more than one labeled feature in the labeled frame, some of those features may be occluded in or missing from certain frames, while others of those features may still be apparent. In such multi-feature images, features that are present may be identified as described below.)

It should also be noted that an occlusion, etc., can last for more than one frame. In such cases, a labeled frame may be adjacent to several unlabeled frames from which a feature is missing. The last of those unlabeled frames can be itself adjacent to an unlabeled frame in which the feature appears. In such a case, provided the labeled frame and the unlabeled frame in which the feature appears are sufficiently temporally close, the intervening frames are passed over.

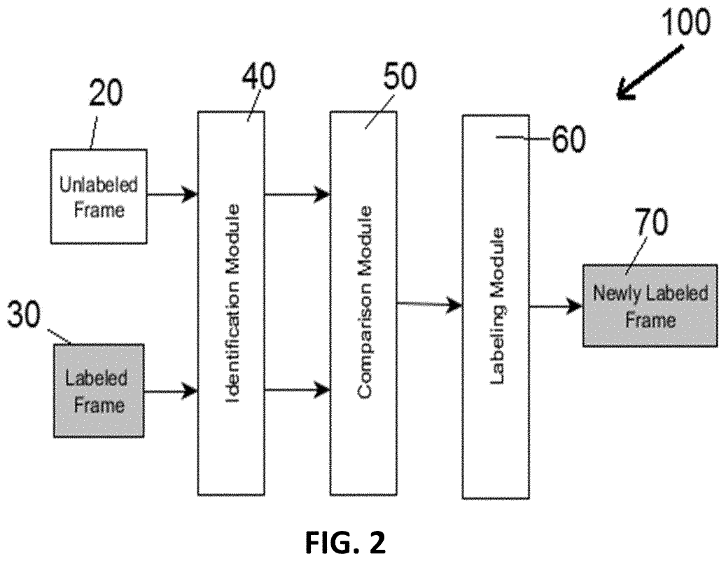

Referring now to FIG. 2, a block diagram of a system according to one aspect of the invention is illustrated. The system 100 has an unlabeled frame 20 and a labeled frame 30, which are passed to an identification module 40. The identification module 40 identifies potential features in the unlabeled frame 20 and labeled features in the labeled frame 30 and passes the frames with the feature information to a comparison module 50. The comparison module 50 compares potential features from the unlabeled frame 20 to labeled features from the labeled frame 30. If a potential feature is found to match a specific feature from the labeled frame, the unlabeled frame 20 and the location of the potential feature are passed to a labeling module 60. The labeling module 60 then applies a label/tag to the potential feature within the unlabeled frame 20, thereby producing a newly labeled frame 70.

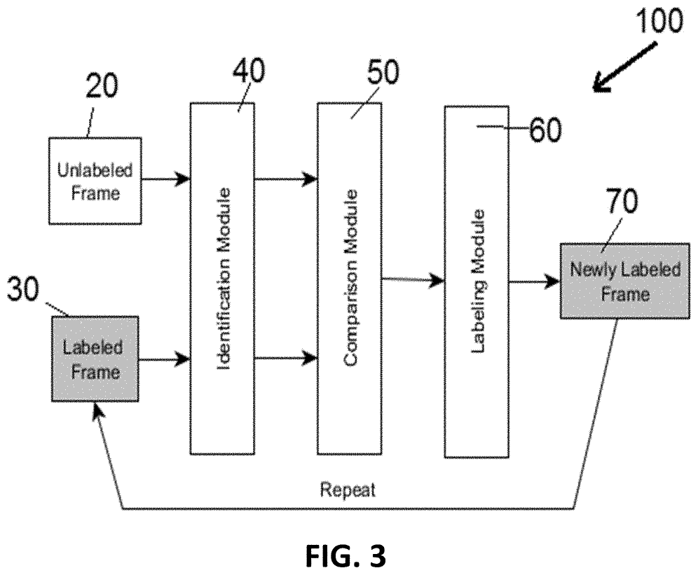

FIG. 3 is a block diagram illustrating a variant of the system of FIG. 2, in which the newly labeled frame 70 is fed back to the system and becomes the ‘labeled frame’ in a repeated feedback process. Clearly, for such variants, the unlabeled frame is not the same in each repetition. Rather, each time a newly labeled frame is fed back, a new unlabeled frame is selected from the video sequence, such that the newly labeled frame and the new unlabeled frame are temporally close, and preferably temporally adjacent, to each other. In this manner, the system can iteratively label every frame in a video sequence by using each newly labeled frame as another input.

Of course, in some video sequences, there may be some frames which contain no features of interest. These frames will cause the identification module to generate an error, and, in some implementations, the frame that caused such an error may be sent to a human for review.

For instance, as discussed above, one or more features that are expected to appear within a certain frame may be occluded from view. As described above, the system 10 determines that the certain frame does not contain the looked-for features. The system then selects a new unlabeled frame.

In some implementations, the entire newly labeled sequence may be sent to a human for post-process review. There are many ways to implement this review process. One possible review process may ask the human reviewer to validate the first frame in the newly labeled sequence and to validate the final frame in the newly labeled sequence. The human reviewer may then be asked to play the resulting sequence and to note if anything looks out of place.

Additionally, the identification module 40 may take into account the location of features within a video frame. In such implementations, that is, features can be identified based on where they appear in any given labeled frame 30 and compared only to potential features in a similar region of an unlabeled frame 20. Identifying features based on their region within the image in this way provides multiple advantages. For one, rather than comparing every possible potential feature in an entire unlabeled image to a certain feature, the comparison module 50 can look only at potential features within a subset of the unlabeled frame, which improves the comparison speed.

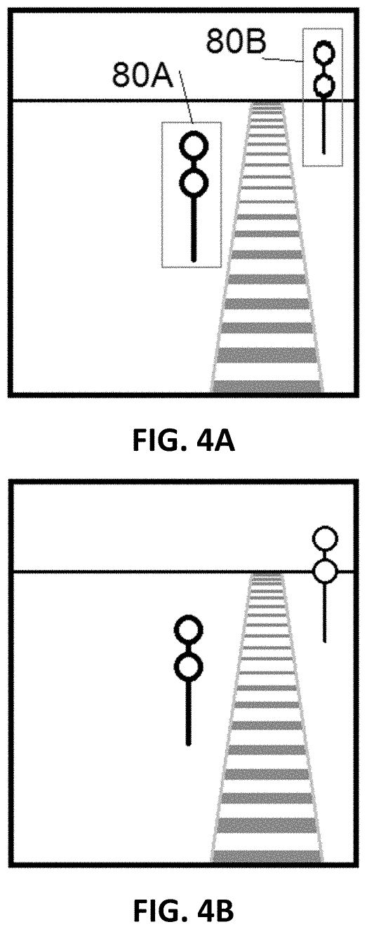

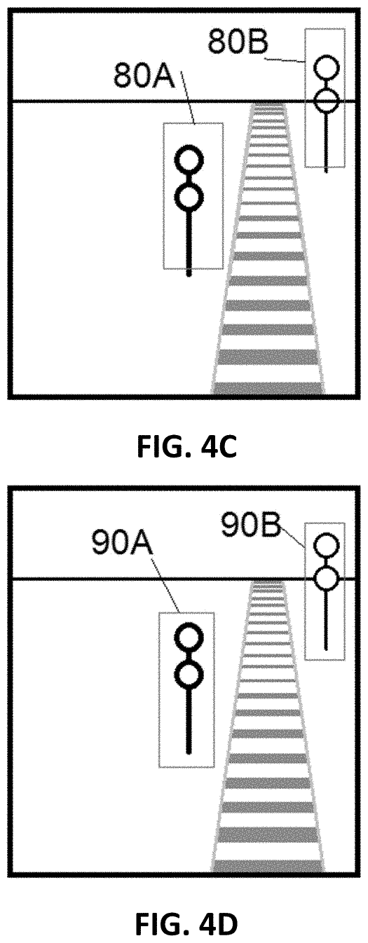

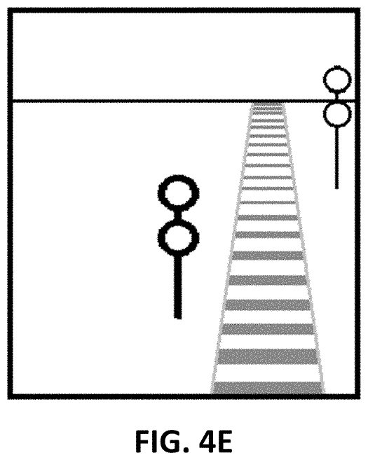

For instance, FIG. 4A shows a labeled frame containing a stylized “railroad” has and stylized “signals” on either side of the railroad. The signals are delineated by bounding boxes 80A and 80B. The identification module, then, may identify the location of the leftmost bounding box as being within a “central” region, and the location of the rightmost bounding box as being within an “upper-right” region. (It should of course be clear that these region ‘names’ are purely exemplary. More commonly, the identification module would determine the location of the bounding boxes based on their locations in the two-dimensional pixel space of the frame.) Although most features of interest will likely have slightly different locations from frame to frame, in most implementations the slight differences between temporally close frames will be negligible, as can be seen in FIG. 4B. In FIG. 4B, which is temporally close to the frame of FIG. 4A, the signals are both slightly larger and slightly closer to the bottom of the frame than they were in FIG. 4A. The new locations, however, are not dramatically different from those in FIG. 4A, as can be seen in FIG. 4C. FIG. 4C shows the image of FIG. 4B with the bounding boxes 80A and 80B from FIG. 4A applied. It is clear that, although the labels 80A and 80B do not perfectly fit the signals in FIG. 4C, they are fairly close. Thus, when the identification module 40 receives an unlabeled frame, it is generally reasonable for that identification module 40 to begin searching for potential features in the unlabeled frame in the same approximate location of features in the labeled frame.

FIG. 4D, then, shows the frame of FIG. 4B with bounding boxes 90A and 90B correctly applied to the signals. That is, FIG. 4B shows an unlabeled frame 20 and FIG. 4D shows the same frame as a newly labeled frame 70, produced as output by the invention. That newly labeled frame 70 can then be fed back to the identification module 40 as the new ‘labeled frame 30’, to be used to label features in another unlabeled frame (e.g., in FIG. 4E, another unlabeled frame from the same sequence as FIGS. 4A and 4B). This feedback process then repeats until all frames in the sequence have been labeled.

In some embodiments of the present invention, the identification module 40 includes a neural network. As is well-known, neural networks typically comprise many layers. Each layer performs certain operations on the data that each layer receives. A neural network can be configured so that its output is an “embedding” (or “representation”) of the original input data. The degree of simplification depends on the number and type of layers and the operations they perform.

It is possible, however, to only use a portion of the available layers in that neural network. For instance, a video frame can be passed to a neural network having 20 internal layers, but only processed by the 18^{th} or 19^{th} layer, or their combination. An embedding retrieved after only a few high-level layers have processed the video frame would therefore contain fairly high-level feature information. Such an embedding can be thought of as a “signature” of the initial video frame. This signature is sufficiently detailed as to be distinct for each frame and is typically a numerical tensor. Non-numerical signatures are possible, however, depending on the configuration of the neural network. It should also be understood that the neural network may focus on specific regions of a single frames, thereby producing “region signatures”. For instance, if a labeled frame is passed to the neural network, the neural network can be configured to produce signatures for each labeled area. These signatures can thus be understood as “feature signatures”, each identifying a specific feature within the labeled frame.

The neural network can then process an unlabeled video frame using the same layers as were used to process the labeled frame. As there are no labeled areas in the unlabeled frame, however, the neural network will not be able to easily locate areas on which to focus. In one implementation, then, the neural network will randomly choose areas within the frame and produce a trial signature for each random area. The neural network then passes the feature signatures from the labeled video frame and the random-area trial signatures from the unlabeled frame to the comparison module 50. The comparison module 50 then compares each random-area trial signature to a specific feature signature from the labeled frame. The comparison module 50 may use such well-known operations as cosine distance, covariance, and correlation as the basis for rule-based comparisons. However, in some implementations, the comparison module 50 may use another neural network. In one implementation, this other neural network is trained to compare signatures and to determine points of importance within them. Data on those points of importance can then be used to inform later comparisons.

Because each signature is distinct and detailed, if any match is found between a specific random-area trial signature and that specific feature signature, it can be concluded that the specific random area contains that specific feature. The comparison module will then pass the unlabeled video frame and the location of the specific random area within that frame to the labeling module 60. The labeling module 60 then applies a label to the random area within the unlabeled frame, to thereby produce a newly labeled frame 70. To avoid infinite loops, the number of random signatures that the neural network produces is preferably limited. For instance, in one implementation, the number of random signatures is limited to 5000.

Alternatively, in another implementation, the neural network can identify pseudo-random areas, loosely based on the location of features in the labeled frame, as discussed above. More specifically, if a label on the labeled frame is centered on particular coordinates in the two-dimensional image space, the neural network may look for potential features around that central point. For instance, the label in the labeled frame may be centered on pixel coordinates (10, 10) and have corners at (5, 5), (5, 15), (15, 5), and (15, 15) (i.e., a “radius” of 5 pixels in each direction from the central point). (Again, of course, these values are exemplary, and that labels are not required to be rectangular or square.) Then, when processing the unlabeled frame, the neural network can focus on regions centred at (10, 10). The neural network could then produce signatures for pseudo-random regions with randomized “radii”. For instance, various pseudo-random regions could be centred on (10, 10) and have “radii” of 1 pixel, 20 pixels, 7 pixels, and so on. In such implementations, additionally, it may be preferable to pass each pseudo-random-area signature to the comparison module as that pseudo-random-area signature is determined Such an approach would prevent a slew of unnecessary signatures being determined. Once a pseudo-random-area signature has been determined to match a feature signature from the labeled frame, the neural network can simply move on.

In most implementations of the present invention, an exact match between signatures is highly unlikely. That is, many if not most of the relevant features of interest will change shape and/or scale from frame to frame, even if only slightly (as seen in FIGS. 4A-4E). Thus, exact signature matches will often not be possible. To account for this, the comparison module is preferably configured to determine matches within a margin of tolerance. That margin of tolerance should be set to a level that incorporates scaling differences between frames, and thus may vary depending on the video sequence in question.

In implementations using a neural network, the neural network is preferably a pre-trained convolutional neural network (CNN). CNNs are known to have advantages over other neural networks when used for image processing.

In other embodiments of the present invention, however, the identification module 40 can be a rule-based module, rather than a neural network that extracts “signatures”. Such an identification module 40 would identify features by identifying particular parameters of each feature. These feature parameters can be related to the feature's location within the frame, the feature's colour, and/or the feature's shape, among other attributes of the feature. Likewise, in such an embodiment, the identification module 40 would identify each potential feature by identifying potential-feature parameters that are comparable to the feature parameters already identified. Such an identification module 40 may use well-known rule-based techniques, including without limitation: direct pixel correlation; direct pixel correlation with “canny” filtering (for instance, edge detection filters); and/or such traditional feature detection techniques as scale-invariant feature transforms (SIFT detectors).

As should be evident, the feature parameters and potential-feature parameters can take any convenient form. They can be represented as words or as numerical values, or as combinations thereof. Further, many feature parameters or potential-feature parameters can be grouped together in groupings that represent individual features or potential features (accordingly). Such groupings may be organized into tensors, multi-dimensional vectors, or any suitable configuration. Grouping parameters in such a manner is preferable, for computational efficiency. These groupings or individual parameters can then be sent to the comparison module 50. (It should also be evident that the ‘feature signatures’ produced by neural networks, as described above, can be considered a specific kind of feature parameter, and that the ‘random-area signatures’ or ‘pseudo-random-area signatures’ can be considered specific kinds of potential-feature parameters.)

In some implementations, all feature comparisons are performed by the comparison module 50 before it passes any information to the labeling module 60. In such implementations, the comparison module 50 may thus contain or communicate with appropriate information storage repositories. However, in other implementations, the comparison module 50 immediately passes the information output of any successful comparison to the labeling module 60. Similarly, in some implementations, the labeling module 60 might not apply any labels to a certain unlabeled frame 20 until it has received information relating to every successful comparison for that unlabeled frame 20. In other implementations, however, the labeling module 60 can label the unlabeled frame 20 as soon as it receives information from the comparison module 50. Thus, in some implementations, the labeling module 60 may have access to an information storage repository, while in others the labeling module may simply act in real-time.

Once the labeling module 60 has applied all appropriate labels to the unlabeled frame 20, that unlabeled frame may be considered a “newly labeled frame” 70. This newly labeled frame 70 can be fed back to the identification module and treated as a new “labeled frame 30”, so that labels can be applied to another unlabeled frame from the video sequence. The processes and comparisons performed by the various modules are the same regardless of whether they are performed on the initial labeled frame 30 or in a later iteration (excepting of course the already discussed potential differences in region delineation). This feedback process is repeated on temporally close frames until all frames in the sequence have at least one label.

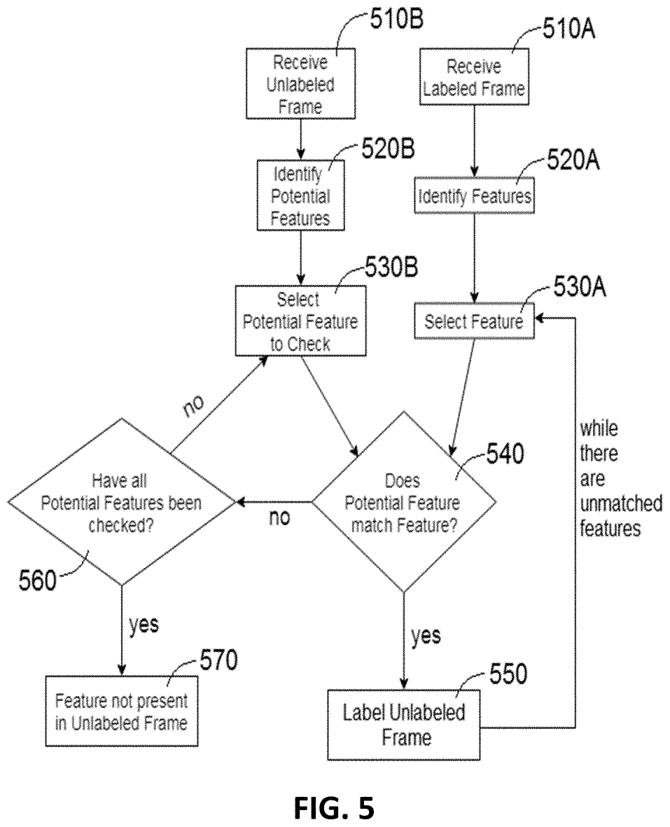

Referring to FIG. 5, a flowchart detailing the steps in a method according to another aspect of the present invention is illustrated. At step 510A, the labeled video frame 30 is received, while the labeled video frame 20 is received at step 510B. Then, at step 520A, labeled features from the labeled frame 30 are identified. As discussed above, that feature identification can be performed in a variety of ways and result in a variety of outputs, including in some cases numeric tensors.

It should also be noted that the order in which steps 510A, 510B, and 520A are performed does not have any effect on the performance of the present invention. That is, the unlabeled frame might be received (step 520A) before the labeled frame is received or its features are identified, or the unlabeled frame might be received after the features of the labeled frame are identified, or the unlabeled frame might be received directly after or at the same time as the labeled frame is received, without materially affecting the performance of the invention.

In many embodiments, however, step 520A must be performed before step 520B, in which potential features in the unlabeled frame are identified. This ordering condition arises when feature location (region) is considered in the identifying steps. That is, if features in a specific region are identified in step 520A, step 520B should only identify features in a similar region of the unlabeled frame. Alternatively, all possible potential features in the unlabeled frame can be identified at step 520B, but this approach may require significant resources.

At step 530A, a specific feature is selected for comparison with a specific potential feature selected in step 530B. That specific feature and specific potential feature are compared at step 540. If they match, the unlabeled frame is labeled at step 550. Any remaining potential features are ignored and, if there are still unmatched features in the labeled frame, the process reverts to step 530A.

If the specific feature and specific potential feature do not match at step 540, however, step 550 cannot occur. Instead, step 560 determines if all the appropriate potential features have been compared to that specific feature. If not (i.e., there are potential features that have not been checked), the process reverts to step 530B and a new potential feature is selected. If all appropriate potential features have been compared to the specific feature, however, the specific feature is not present in the unlabeled frame. In such cases, as mentioned above, an error occurs and the unlabeled frame may be sent to a human for review.

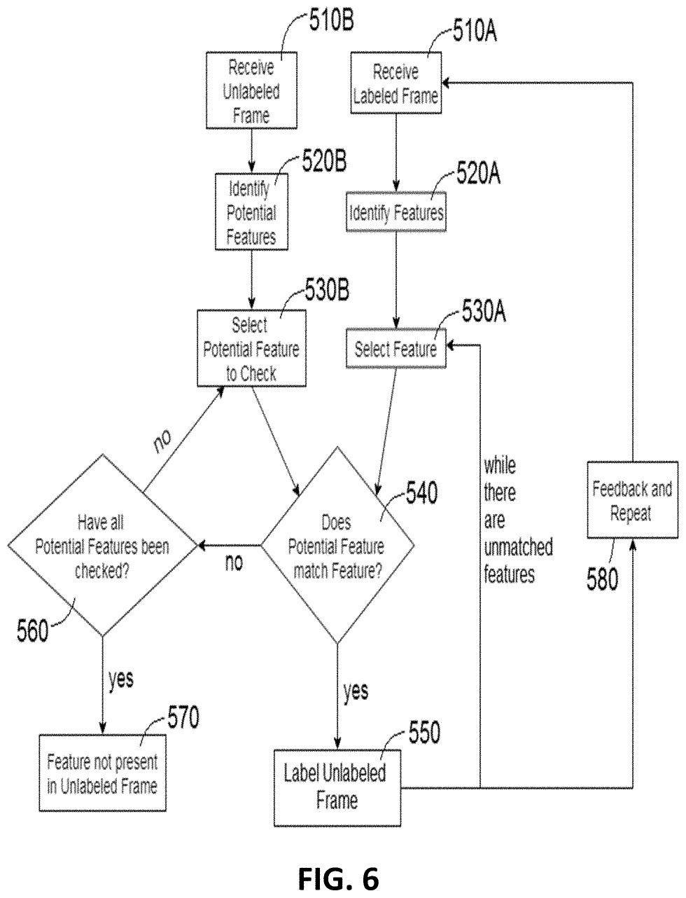

FIG. 6 is another flowchart detailing a variant of the method in FIG. 5. This method differs from that in FIG. 5 only in the presence of a feedback step (step 580), in which a newly labeled frame is fed back and received as a new input at step 510. As discussed above, a new unlabeled frame is selected from the video sequence (the new unlabeled frame being temporally close if not temporally adjacent to the newly labeled frame), that new unlabeled frame is received in step 510B, and the method repeats.

It should be clear that the various aspects of the present invention may be implemented as software modules in an overall software system. As such, the present invention may thus take the form of computer executable instructions that, when executed, implements various software modules with predefined functions.

The embodiments of the invention may be executed by a computer processor or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g., “C” or “Go”) or an object-oriented language (e.g., “C++”, “java”, “PHP”, “PYTHON” or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

What is claimed is:

1. A method for labeling an unlabeled frame within a sequence of frames, the method comprising:
(a) receiving said unlabeled frame and a labeled frame from said sequence, said labeled frame being temporally close to said unlabeled frame within said sequence;
(b) identifying at least one labeled feature in said labeled frame;
(c) identifying at least one potential feature in said unlabeled frame;
(d) comparing said at least one potential feature with said at least one labeled feature; and
(e) applying a label to said unlabeled frame when said at least one potential feature matches said at least one said labeled feature, to thereby produce a newly labeled frame.

2. The method according to claim 1, wherein said at least one labeled feature has a specific location within said labeled frame and said at least one potential feature has a similar location within said unlabeled frame, said similar location being similar to said specific location of said at least one labeled feature within said labeled frame, and wherein said at least one potential feature is identified in step (b) based on said similar location.

3. The method according to claim 1, wherein step (b) comprises passing said labeled frame through an identification module to thereby identify at least one feature parameter of said at least one labeled feature.

4. The method according to claim 3, wherein step (c) comprises passing said unlabeled frame through said identification module, to thereby identify at least one potential-feature parameter of said at least one potential feature.

5. The method according to claim 4, wherein step (d) comprises comparing said at least one potential-feature parameter to said at least one feature parameter.

6. The method according to claim 5, wherein said at least one potential-feature parameter matches said at least one feature parameter when at least one of the following occurs:
said potential-feature parameter is the same as said feature parameter; and
a difference between said potential-feature parameter and said feature parameter is within a margin of tolerance.

7. The method according to claim 3, wherein said identification module is one of: a neural network and a convolution neural network.

8. The method according to claim 4, wherein said at least one feature parameter and said at least one potential feature parameter are numeric tensors.

9. The method according to claim 1, further comprising the steps of:
(f) receiving a second unlabeled frame from within said sequence, said second unlabeled frame being temporally close to said newly labeled frame; and
(g) performing steps (a)-(e) with said second unlabeled frame in place of said unlabeled frame and said newly labeled frame in place of said labeled frame.

10. The method according to claim 9, wherein steps (a)-(g) are iteratively performed until all frames within said sequence have at least one label.

11. A method for labeling an unlabeled frame within a sequence of frames, the method comprising:
(a) receiving said unlabeled frame and a labeled frame from said sequence, said labeled frame being temporally close to said unlabeled frame within said sequence;
(b) identifying at least one labeled feature in said labeled frame;
(c) identifying a specific location of said at least one labeled feature within said labeled frame;
(d) generating a specific signature of a specific region of said labeled frame, said specific region being based on said specific location;
(e) identifying a similar location within said unlabeled frame, said similar location being a location within said unlabeled frame that is similar to said specific location within said labeled frame;
(f) generating a random trial signature of a random trial region of said unlabeled frame, said random trial region being based on said similar location;
(g) comparing said random trial signature to said specific signature;
(h) repeating steps (f)-(g) until an exit condition is met, wherein said exit condition is one of:
said random trial signature matches said specific signature within a margin of tolerance; and
a predetermined number of iterations are performed.

12. The method according to claim 11, wherein said specific signature and said random trial signature are generated by one of: a neural network and a convolutional neural network.

13. The method according to claim 11, wherein said specific signature and said random trial signature are numeric tensors.

14. A system for labeling an unlabeled frame within a sequence of frames, the system comprising:
an identification module for:
receiving said unlabeled frame and a labeled frame from said sequence, said labeled frame being temporally close to said unlabeled frame within said sequence;
identifying at least one labeled feature in said labeled frame; and
identifying at least one potential feature in said unlabeled frame;
a comparison module for comparing said at least one potential feature to said at least one labeled feature; and
a labeling module for applying a label to said unlabeled frame when said comparison module determines a match between at least one potential feature and at least one labeled feature, said labeling module thereby produce a newly labeled frame.

15. The system according to claim 14, wherein said at least one labeled feature has a specific location within said labeled frame, and wherein said at least one potential feature has a similar location within said unlabeled frame, said similar location being similar to said specific location of said at least one labeled feature within said labeled frame, and wherein said identification module identifies said at least one potential feature based on said similar location.

16. The system according to claim 14, wherein said identification module identifies at least one feature parameter of said at least one labeled feature, and wherein said identification module identifies at least one potential-feature parameter of said at least one potential feature.

17. The system according to claim 14, wherein said comparison module compares said at least one potential-feature parameter to said at least one feature parameter.

18. The system according to claim 17, wherein said at least one potential-feature parameter matches said at least one feature parameter when at least one of the following occurs:
said potential-feature parameter is the same as said feature parameter; and
a difference between said potential-feature parameter and said feature parameter is within a margin of tolerance.

19. The system according to claim 14, wherein said identification module is one of: a neural network and a convolution neural network.

20. The system according to claim 14, wherein said at least one feature parameter and said at least one potential-feature parameter are numeric tensors.

21. The system according to claim 14, wherein said newly labeled frame is fed back to said identification module and said identification module further receives a second unlabeled frame from said sequence, and wherein said second unlabeled frame is temporally close to said newly labeled frame, and wherein said system uses said newly labeled frame to label said second unlabeled frame, to thereby produce a second newly labeled frame via a feedback process.

22. The system according to claim 21, wherein said feedback process is iterated until all frames in said sequence have at least one label.

23. Non-transitory computer-readable media having stored thereon computer-readable and computer-executable instructions, which, when executed, implement a method for labeling an unlabeled frame within a sequence of frames, the method comprising:
(a) receiving said unlabeled frame and a labeled frame from said sequence, said labeled frame being temporally close to said unlabeled frame within said sequence;
(b) identifying at least one labeled feature in said labeled frame;
(c) identifying a specific location of said at least one labeled feature within said labeled frame;
(d) generating a specific signature of a specific region of said labeled frame, said specific region being based on said specific location;
(e) identifying a similar location within said unlabeled frame, said similar location being a location within said unlabeled frame that is similar to said specific location within said labeled frame;
(f) generating a random trial signature of a random trial region of said unlabeled frame, said random trial region being based on said similar location;
(g) comparing said random trial signature to said specific signature;
(h) repeating steps (f)-(g) until an exit condition is met, wherein said exit condition is one of:
said random trial signature matches said specific signature within a margin of tolerance; and
a predetermined number of iterations are performed.

24. The computer-readable media according to claim 23, wherein said specific signature and said random trial signature are generated by a one of: a neural network and a convolution network.

25. The computer-readable media according to claim 24, wherein said specific signature and said random trial signature are numeric tensors.
